(19) United States
(12) Patent Application Publication
(10) Pub. No.: US 2013/0056613 A1
(43) Pub. Date: Mar. 7, 2013

(54) Grommet Mounting Assembly

(71) Applicant: Holly Thomas, Avon, IN (US)

(72) Inventor: Holly Thomas, Avon, IN (US)

(73) Assignee: Carrier Corporation, Farmington, CT (US)

(21) Appl. No.: 13/375,025

(22) PCT Filed: Jun. 3, 2010
(86) PCT No.: PCT/US2010/037151

§ 371 Date: Jul. 23, 2012

Related U.S. Application Data
(60) Provisional application No. 61/184,457, filed on Jun. 5, 2009.

(51) Int. Cl. F16M 13/00; F16F 15/08

(52) U.S. Cl. 248/677; 248/638

(57) ABSTRACT

A mounting assembly for mounting a mounting foot to a base pan comprises a grommet, a mounting foot and a fastener. The grommet includes a body, an upper post and a lower post. The upper post extends from a first end the body and the lower post extends from a second end of the body. The upper post has a shoulder. The mounting foot has a mount opening for receiving the upper post. The mount opening has a diameter. The fastener is received on the upper post, and maintains the mounting foot on the upper post. The mounting foot has a thickness less than the thickness of the shoulder.

### BACKGROUND

Compressors for refrigeration, air conditioning and heat pump systems are typically mounted to a base pan. In order to dampen vibrations and the resultant noise caused by the operation of the compressor, vibration isolating mounting assemblies can be located between the feet of the compressor and the base pan. For example, elastomeric grommets can be located between the feet of the compressor and the base pan to which it is mounted to reduce the vibrations transferred from the compressor mounting feet to the base pan. U.S. Pat. No. 5,221,192 by Heflin et al. discloses a split post grommet, which has two threaded ends that extend from the body of the grommet in opposite directions. The first threaded end attaches the grommet to the base pan. The second threaded end attaches the grommet to the compressor by receiving a compressor mounting foot and a washer. A nut is received on the second end of the grommet to prevent or limit vertical movement of the compressor mounting foot.

### SUMMARY

A mounting assembly for mounting a mounting foot to a base pan comprises a grommet, a mounting foot and a fastener. The grommet includes a body, an upper post and a lower post. The upper post extends from a first end the body and the lower post extends from a second end of the body. The upper post has a shoulder. The mounting foot has a mount opening for receiving the upper post. The mount opening has a diameter. The fastener is received on the upper post, and maintains the mounting foot on the upper post. The mounting foot has a thickness less than the thickness of the shoulder.

### BRIEF DESCRIPTION OF THE DRAWINGS

FIG. 1 is a perspective view of a compressor mounted to a base pan by a mounting assembly.

FIG. 2 is an enlarged perspective view of the mounting assembly of FIG. 1 having a straight shoulder grommet.

FIG. 3 is a cross-sectional view of the mounting assembly taken along line 3-3 of FIG. 2.

### DETAILED DESCRIPTION

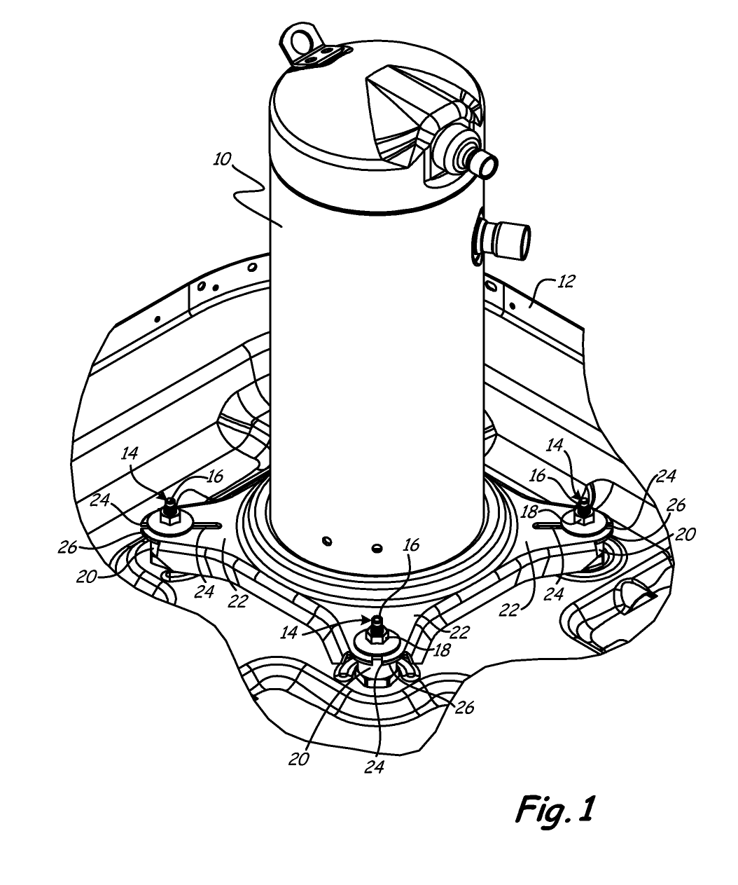

FIG. 1 is a perspective view of a compressor assembly comprising compressor 10, base pan 12 and mounting assemblies 14 each of which includes upper post 16, fastener 18 and grommet body 20. A plurality of compressor mounting feet 22 extend from compressor 10, and each compressor mounting foot 22 includes channel 24 and end 26. Mounting assemblies 14 secure compressor 10 to base pan 12. Upper post 16 extends from grommet body 20 through compressor mounting foot 22, and is secured by fastener 18. Upper post 16 can be, for example, a grommet stud or a bolt. Fastener 18 can be any suitable means for maintaining compressor mounting foot 22 on upper post 16. In one example, upper post 16 is threaded and fastener 18 is capable of accepting the threads of upper post 16. For example, fastener 18 can be a nut, a nut and washer or a flange nut. A lower post (not shown in FIG. 1) extends from grommet body 20 opposite upper post 16 and attaches to base pan 12.

Compressor 10 can be any compressor suitable for use in an air conditioning unit or an air handling unit. During operation, compressor 10 produces vibrations and resulting noises. These vibrations are transferred through compressor mounting feet 22 to base pan 12. Mounting assemblies 14 vibrationally and acoustically isolate compressor 10 from base pan 12 to reduce the vibrations and noises generated during operation of compressor 10.

Each compressor mounting foot 22 includes channel 24 that extends to end 26 of compressor mounting foot 22. Channel 24 provides additional freedom to compressor mounting foot 22 and assists in eliminating vibration transmission through compressor mounting foot 22 to base pan 12. As described further below, compressor mounting foot 22 is not firmly clamped between grommet body 20 and fastener 18, because such clamping negates the benefits of channel 24. Instead, mounting assembly 14 allows vertical motion of compressor mounting foot 22, which assists in eliminating vibration transmissions from compressor mounting foot 22 to base pan 12.

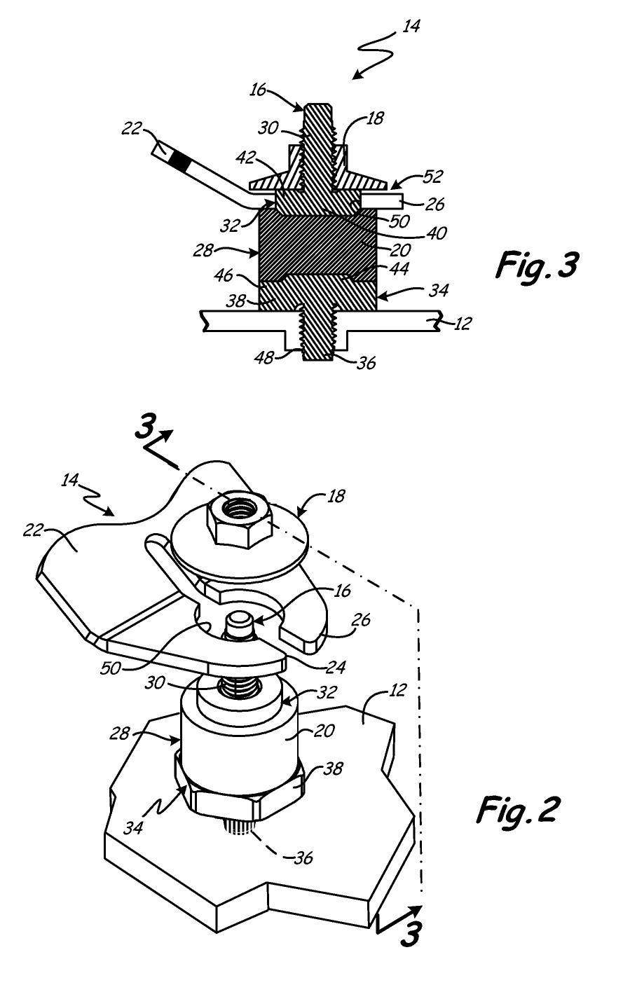

FIG. 2 is an enlarged perspective view of mounting assembly 14, and FIG. 3 is a cross-sectional view of mounting assembly 14 taken along line 3-3 of FIG. 2. Mounting assembly 14 includes grommet 28, compressor mounting foot 22 and fastener 18. Grommet 28 includes upper post 16 (having threaded portion 30 and shoulder 32), grommet body 20 and lower post 34 (having threaded portion 36 and hex head 38). Grommet body 20 is made from an elastomeric or resilient material, such as rubber or neoprene. Upper post 16 and lower post 34 extend from opposite ends of grommet body 20. Grommet body 20 is integrally formed with upper post 16 and lower post 34. For example, grommet 28 can be formed by molding rubber between upper post 16 and lower post 34.

Embedded portion (or top plate) 40 of upper post 16 is embedded in grommet body 20, while non-embedded portion 42 of upper post 16 is not embedded in grommet body 20. Similarly, embedded portion 44 of lower post 34 is embedded, and non-embedded portion 46 of lower post 34 is not embedded in grommet body 20. Embedded portion 40 of upper post 16 has a smaller diameter than embedded portion 44 of lower post 34, as will be described further below.

Lower post 34 attaches grommet 28 to base pan 12 and includes threaded portion 36 and head 38. Lower post 34 is connected to base pan 12 by driving threaded portion 36 through hole 48 in base pan 12. Head 38 allows a wrench to be directly applied to lower post 34 when lower post 34 is attached to base pan 12. This prevents the torque required to drive lower post 34 into place from traveling through grommet body 20.

Upper post 16 extends from grommet body 20 opposite of lower post 34 and includes threaded portion 30 and shoulder 32. Threaded portion 30 and shoulder 32 include a non-elastomeric material such as a metal. Shoulder 32 is a straight shoulder having a uniform diameter. The uniform diameter of shoulder 32 allows compressor mounting foot 22 to be easily slipped over shoulder 32.

Grommet body 20, threaded portion 30 and shoulder 32 have different diameters. Shoulder 32 has a larger outer diameter than threaded portion 30 and a smaller outer diameter than grommet body 20. In one example, shoulder 32 has an outer diameter of about 18.5 mm, threaded portion 30 has an outer diameter of about 6 mm and grommet body has an outer diameter of about 25 mm. The different diameters of grommet body 20, threaded portion 30 and shoulder 32 assist in assembly of mounting assembly 14, as is described further below.

A plurality of compressor mounting feet 22 extend from compressor 10. Each compressor mounting foot 22 includes channel 24, bore (or mount opening) 50 and end 26. Channel 24 extends from bore 50 to end 26 of compressor mounting foot 22. Channel 24 provides some freedom of motion to compressor mounting foot 22 and reduces vibration transmissions from compressor mounting foot 22 through grommet 28 to base pan 12. Bore 50 accepts upper post 16.

Fastener 18 maintains mounting foot 22 on grommet 28. Fastener 18 is capable of accepting the threading of upper post 16. For example, fastener 18 can be a flange nut. The wide base of a flange nut allows fastener 18 to apply pressure over a greater surface area than a nut alone. Alternatively, fastener 18 can be a nut and washer.

When mounting assembly 14 is assembled, grommet 28 receives compressor mounting foot 22 and fastener 18. Upper post 16 extends through bore 50 of compressor mounting foot 22, and threaded portion 30 of upper post 16 receives fastener 18 so that flange nut maintains mounting foot 22 on grommet 28. The diameter of bore 50 of compressor mounting foot 22 is larger than the outer diameter of shoulder 32 and smaller than the outer diameter of grommet body 20. Compressor mounting foot 22 surrounds shoulder 32 and rests on grommet body 20. In one example, shoulder 32 is sized to substantially fill bore 50.

Mounting assembly 14 is designed so that compressor mounting foot 22 is not tightly clamped against grommet 28. Shoulder 32 is thicker than mounting foot 22 so when assembled and flange nut is tightened to the end of threaded portion 30, gap 52 is formed between fastener 18 and compressor mounting foot 22. Gap 52 prevents fastener 18 from tightly clamping compressor mounting foot 22 to grommet body 20. Gap 52 provides a small amount of clearance between compressor mounting foot 22 and fastener 18, and allows some vertical motion of compressor mounting foot 22. This, in conjunction with channel 24 of compressor mounting foot 22 reduces or eliminates vibration transmission through compressor mounting foot 22 to base pan 12. In one example, shoulder 32 is between about 4 and 5 mm thick and compressor mounting foot 22 is between about 3 and 3.5 mm thick. In another example, gap 52 is between about 1 and 1.5 mm thick.

As configured, shoulder 32 acts as a positive step for fastener 18. Because shoulder 32 is thicker than compressor mounting foot 22, shoulder 32 prevents fastener 18 from tightly clamping compressor mounting foot 22 against grommet body 20 when fastener 18 is fully tightened on grommet 28. Shoulder 32 creates gap 52 without additional parts, maintaining the simplicity of mounting assembly 14.

The reduced diameter of embedded portion 40 of upper stub 16 also assists in reducing or eliminating vibrational noises generated during operation of compressor 10. As previously described, upper post 16 includes embedded portion 40 and non-embedded portion 42. As shown in the cross-sectional view of FIG. 3, the diameter of embedded portion 40 and the diameter of non-embedded portion 42 are less than the diameter of bore 50 of compressor mounting foot 22 so that compressor mounting foot 22 is completely supported by grommet body 20. Further, compared to embedded portion 44 of lower post 34, the diameter of embedded portion 40 of upper post 16 has been reduced.

Mounting assembly 14 is designed to provide some vertical freedom to compressor mounting foot 22. Reducing the diameter of embedded portion 40 of upper post 16 prevents compressor mounting foot 22 from resting or being either partially or completely supported by embedded portion 40, and reduces or eliminates vibrational noises that can be produced by such a configuration. When compressor mounting foot 22 is completely supported by the elastomeric material of grommet body 20, the elastomeric material of the grommet body absorbs the vibrations transmitted through compressor mounting foot 22. Further, no or only very slight vibration induced noise is produced by the interaction of compressor mounting foot 22 and grommet body 20.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A mounting assembly comprising:
a grommet having a body, an upper post extending from a first end of the body and a lower post extending from a second end of the body, the upper post having a shoulder;
a mounting foot having a mount opening for receiving the upper post, the mounting opening having a diameter; and
a fastener received on the upper post for maintaining the mounting foot on the upper post, wherein the mounting foot has a thickness less than a thickness of the shoulder.

2. The mounting assembly of claim 1, wherein the shoulder has a smaller diameter than the diameter of the mount opening.

3. The mounting assembly of claim 1, wherein the mounting foot rests completely on the body of the grommet.

4. The mounting assembly of claim 1, further comprising a gap between the fastener and the mounting foot.

5. The mounting assembly of claim 1, wherein the upper post comprises:
an embedded portion having a diameter; and
a non-embedded portion having a diameter, wherein the diameter of the embedded portion and the diameter of the non-embedded portion are less than the diameter of the mount opening.

6. An air handling unit comprising:
a base pan;
a compressor mounted to the base pan, the compressor having a mounting foot;
a fastener; and
a grommet for mounting the compressor to the base pan, the grommet comprising:
a lower post for connecting to the base pan;
an upper post for receiving the mounting foot and the fastener, the upper post having a shoulder and a threaded portion, wherein the shoulder is sized to create a gap between the mounting foot and the fastener; and
an elastomeric middle section secured between the lower post and the upper post for isolating the vibrations from the compressor from the base pan.

7. The air handling unit of claim 6, wherein the mounting foot comprises a mount opening having a diameter for accepting the upper post, and wherein the shoulder has a diameter less than the diameter of the mount opening.

8. The air handling unit of claim 7, wherein the upper post comprises:
an embedded portion having a diameter; and
a non-embedded portion having a diameter, wherein the diameter of the embedded portion and the diameter of the non-embedded portion are less than the diameter of the mount opening.

9. The air handling unit of claim 6, wherein the mounting foot comprises a mount opening for accepting the upper post, and wherein the mount opening rests completely on the body of the grommet.

10. A compressor assembly comprising:
a compressor;
a mounting foot extending from the compressor, the mounting foot having a thickness and a mount opening with an diameter; and
a grommet connected to the mounting foot, the grommet comprising:
a body;
an upper post extending from a first end of the body for receiving the mounting foot, the upper post having a shoulder with a thickness greater than the thickness of the mounting foot; and
a lower post extending from a second end of the body.

11. The compressor assembly of claim 10, wherein the shoulder has a smaller diameter than the diameter of the mount opening.

12. The compressor assembly of claim 10, wherein the mounting foot rests completely on the body of the grommet.

13. The compressor assembly of claim 10, further comprising:
a fastener received on the upper post for maintaining the mounting foot on the upper post; and
a gap between the fastener and the mounting foot.

14. The compressor assembly of claim 10, wherein the upper post comprises:
an embedded portion having a diameter; and
a non-embedded portion having a diameter, wherein the diameter of the embedded portion and the diameter of the non-embedded portion are less than the diameter of the mount opening.
